(19) United States
(12) Patent Application Publication
(10) Pub. No.: US 2006/0059662 A1
(43) Pub. Date: Mar. 23, 2006

(54) Projection reinforced, five knuckle, hospital tip overlay hinge

(76) Inventor: Daniel L. Roeper, Garden City, NY (US)

Correspondence Address: Daniel L. Roeper, 50 Carnation Avenue, Building #3, Floral Park, NY, 11001, US

(21) Appl. No.: 11/223,650

(22) Filed: Sep. 7, 2005

Related U.S. Application Data
(60) Provisional application No. 60/612,238, filed on Sep. 22, 2004.

(51) Int. Cl. E05D 5/00

(52) U.S. Cl. 16/382

(57) ABSTRACT

An overlay hinge comprising of a door wing (12) and frame wing (10) held together by a pin (14). The said frame wing possesses stamped protrusions (16) at the location of the outmost bends (22). The said stamped protrusions act as reinforcement for the hinge under load.

### CROSS-REFERENCE TO RELATED APPLICATIONS

U.S. Application No. 60/612,238

Filing Date: Sep. 22, 2004

Name of Applicant: Daniel Roeper

Title of Invention: PROJECTION REINFORCED, FIVE KNUCKLE, HOSPITAL TIP OVERLAY HINGE

### FEDERALLY SPONSORED RESEARCH Not Applicable SEQUENCE LISTING OR PROGRAM

Not Applicable

### BACKGROUND OF THE INVENTION—FIELD OF INVENTION

This invention relates to hinges, specifically five knuckle, hospital tip, stainless steel overlay hinges used on larger doors.

### BACKGROUND OF THE INVENTION

Overlay hinges are designed to allow the door to close outside the frame and permit wide pivot angles when compared to common door hinges with parallel wings. These characteristics simplify mounting the door and provide a distinct look for the assembly.

Overlay hinges possess two bends on the frame wing and another bend on the door wing. This design feature allows the hinge to wrap around the corner of the frame as well as the door when mounted. When closed, the door will overlap the frame rather than seat inside it.

The main disadvantage of overlay hinges is that they are prone to deflection at the bends. Although the bends are what allow the hinge to have its unique characteristics, they also present an area in which the hinge will deform when overloaded. Hinges are rated for a maximum load; however, over time the hinge may also start to sag under normal operating conditions due to the load. This will cause the door to misalign and function improperly.

Strengthening the hinge is necessary to prevent deflection. One method is to strengthen the material in which the hinge is crafted of. Metal can be hardened by heat treatment. Hardening the hinge will prevent it from yielding, but also make it more brittle. In addition, heat treatment has its own distinct problems. Temperature variations during the heat treatment process may result in inconsistencies in the material. The process will increase production costs due to the additional manufacturing time and handling as well as facilities to perform the process.

Another method of strengthening material is to increase the thickness. Switching to a heavier gauge of metal will increase the amount of material at the weak point and discourage deflection. However, using a thicker material will increase costs for several reasons. It is typically more expensive to obtain thicker material. It also adds mass to the part, which increases shipping and handling costs. Processing the heavier material will also necessitate more work and larger machines, further adding to costs.

Instead of altering the material properties, fasteners such as screws can be used to secure the wing to the frame at the bends. This prevents the wing from bending away from the frame when it is loaded. The disadvantage in using screws is that it requires additional holes to be made on the hinge which increases process time with secondary operations and reduces the strength in that area. The placement of the additional screws also presents a difficult orientation for the consumer to mount the screws.

These methods can improve the functionality of the hinge, but the additional costs, work and handling reduce their overall effectiveness. Strengthening the material unnecessarily affects the entire part rather than the area that is susceptible to deflection. Using screws concentrates on the problematic area; however, it requires additional parts like screws and an extra manufacturing operation to form the hole.

### BACKGROUND OF INVENTION—OBJECTS AND ADVANTAGES

The objects and advantages of my new design are to prevent deflection at the bends on the frame wing while avoiding the disadvantages of the methods mentioned earlier. This can be achieved by stamping projections into the bends to reinforce the hinge at its weakest point. The advantages of these projections are that they:
a) increase the strength of the material at the bends
b) maintain the general profile of the original hinge design
c) can be directly implemented into the original manufacturing process
d) require no additional material
e) remove no material
f) focus directly on the problematic area
g) require no secondary operation
h) require no additional handling
   Stamping a projection on the bend is minimally invasive to the basic design and the cost standpoint of the hinge. From a manufacturing aspect, adding the stamped projections does not require any significant facility. This allows for the most economical improvement of the hinge. Shipping and handling are also unaffected by the addition of the design, further contributing to the maintenance of the cost.

In accordance with the present innovation in overlay hinge design, raised projections stamped into the bends on the frame wing of an overlay hinge act as reinforcement while minimizing detrimental effects of altering the original design.

### DRAWINGS—FIGURES

In the drawings, there are six figures of the overlay hinge with reinforcement projections. They are labeled numerically from 1 to 6.

FIG. 1 illustrates the front perspective view with the stamped projections in view.

FIG. 2 illustrates the back perspective view with the stamped projection in view.

FIG. 3 illustrates the top view.

FIG. 4 illustrates the side view.

FIG. 5 illustrates the front perspective view when the hinge is in the closed position.

FIG. 6 illustrates the separate components and the assembly of the

### DRAWINGS—Reference Numerals

10 frame wing
12 door wing
14 pin
16 stamped projection
18 hole for screw (two on frame wing, three on door wing)
20 hole for screw (adjustable—two on frame wing, two on door wing)
22 area vulnerable to deflection

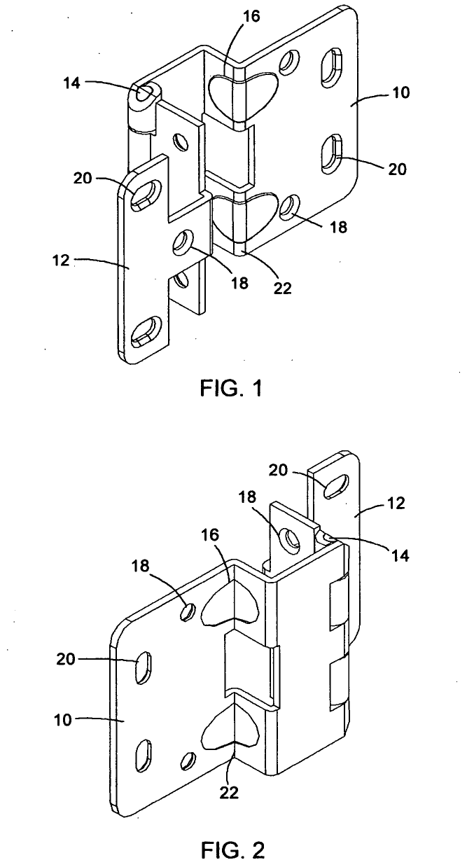

### DETAILED DESCRIPTION—FIGS. 1 AND 2—PREFERRED EMBODIMENT

A preferred embodiment of the closure of the present invention is illustrated in FIG. 1 (front perspective view) and FIG. 2 (back perspective view). The frame wing 10 and door wing 12 of the overlay hinge are stamped out of sheet metal and bent to shape. They are joined using a pin 14. The hinge has holes 18 and adjustable holes 20 to facilitate mounting the hinge to the appropriate areas on the frame and door using screws.

The areas prone to deflection 22 are reinforced by the stamped projections 16. Unlike the bend on the door wing 12, the area vulnerable to deflection 22 has no holes 18, 20 in which a screw can be used to secure it. The projections 16 act as reinforcement by resisting the tendency to deflect outward when the hinge is placed under load.

The projections 16 are stamped in the direction so that they are raised on the side of the frame wing 10 that will be faced away from the frame when mounted. This prevents them from interfering with proper mounting. Illustratively, when viewing FIG. 1 the projections 16 are raised out of the page and towards you.

During manufacturing, the stamping tool will displace the material starting from the back of the frame wing 10. The dimensional criteria of the projections 16 require them to be sufficiently displaced from their original plane without negatively affecting the stability of the surrounding material due to over-displacement.

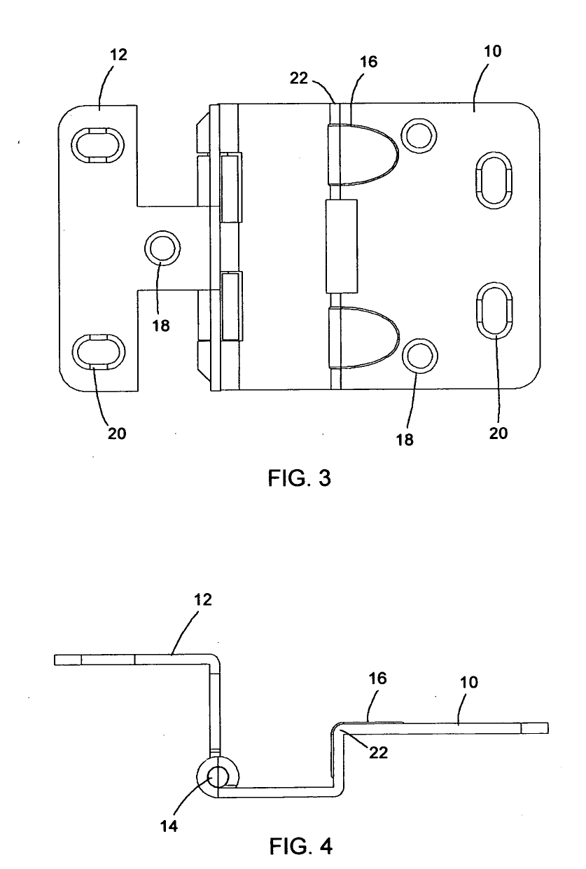

### FIGS. 3-6—ADDITIONAL EMBODIMENTS

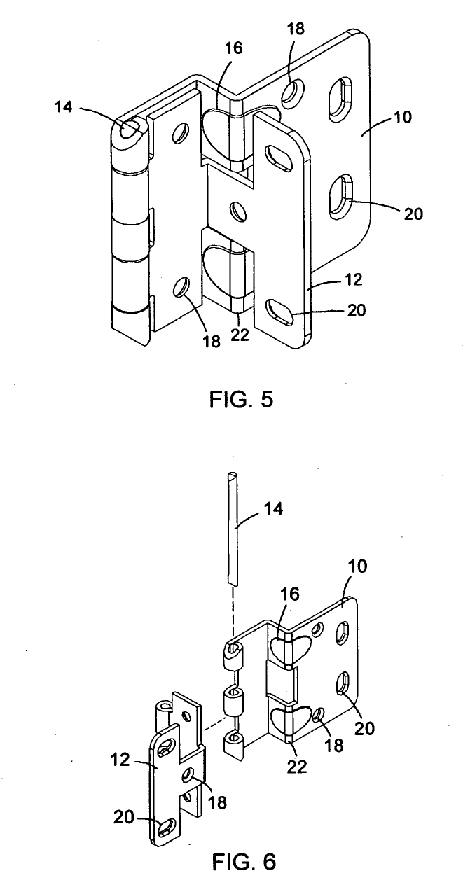

Additional embodiments are shown in FIGS. 3, 4, 5 and 6. In FIG. 3, the top view illustrates the projections on the face of the frame wing. In FIG. 4, the side view illustrates the general profile of the projections as they wrap around the bend. The hinge is in its closed position in FIG. 5, which illustrates that the projections will not interfere with the normal operation of the hinge. In FIG. 6, the assembly of the hinge is illustrated. The hinge comprises of the frame wing, which has corresponding knuckles for the door wing to configure with. The two wings are held together and allowed to rotate on the same axis by the pin.

Operation—FIGS. 1 and 5

The main function of this invention is to resist the forces that would cause an overlay hinge to deflect outward on the frame wing bend when loaded. The hinge is supported by the screws mounted in holes 18, 20 on the frame wing 10 and the door is attached to the hinge by means of screws mounted in holes 18, 20 on the door wing 12. These panels are well secured because the placement of the screws distributes the load across the surface of the wings. However, the vulnerable area 22 is susceptible to deformation under load due to the bend and lack of devices to directly secure it to a solid base.

When the hinge is in its closed position as illustrated by FIG. 5, the weight of the door is relatively well supported by the screws and wings 10, 12. In FIG. 1 where the hinge is opened, the forces acting on the hinge increase due to the shift in load orientation and resulting increased moment force acting on the hinge. This force will attempt to dislocate the hinge from its base, but because the wings 10, 12 are secured by screws, the most susceptible area is the bend 22 on the frame wing 10.

The projections 16 displace the force concentrated at the bends 22, thereby resisting deflection. This increases the strength of the hinge which allows it to take a greater load and continue to operate normally without having to resort to great measures.

Advantages

The reinforcing projections:
(a) Strengthen the area vulnerable to deflection due to the load of the door.

(b) Does not interfere with the normal operating characteristics of the hinge.

(c) Does not alter material characteristics.
(d) Does not change the weight of the hinge.
(e) Requires minimal changes to the manufacturing line.
(f) Is cost efficient from the standpoint of manufacturing to shipping and handling.

### CONCLUSION, RAMIFICATIONS AND SCOPE

Accordingly, the statements on this invention show how these stamped projections reinforce the critical areas of an overlay hinge, consequentially strengthening the hinge. This is achieved without adding to the complexity and cost of the hinge. The heavy-duty nature of the hinge is further strengthened without sacrificing the functionality. Additionally, the projections increase the service life of the hinge by preventing sag from the constant load over time.

Although the description above contains many specifications, these should not be construed as limiting the scope of the invention but merely providing illustrations of some of the presently preferred embodiments of the invention. For example, the stamped projection may be of multiple raised sections, such as that of a corrugated design; the projections can be of various shapes and sizes as long as it does not interfere with the functionality of the hinge; use of various materials to fabricate the hinge; different knuckle constructions; different tips at the ends of the knuckle alignment, etc.

Thus the scope of the invention should be determined by the appended claims and their legal equivalents, rather than by the examples give.

I claim:

1. An overlay hinge comprising of a door wing, frame wing, five knuckles, hospital tip and pin, the improvement wherein said hinge possesses stamped projections.

2. The hinge of claim 1 wherein the material of construction is stainless steel.

3. The hinge of claim 1 wherein said projections are stamped into the bent corner of the said frame wing.

4. The hinge of claim 2 wherein said projections are stamped in the direction of the mounting surface of said frame wing to the exposed surface of said frame wing.

5. The hinge of claim 3 wherein said projections are stamped in the location of said bent corner in a manner that fully contains one side of said bent corner to the other side of said bent corner thereof.
